(19) United States
(12) Patent Application Publication
(10) Pub. No.: US 2018/0349720 A1
(43) Pub. Date: Dec. 6, 2018

(54) SOUND AND IMAGE IDENTIFIER SOFTWARE SYSTEM AND METHOD

(71) Applicant: Dawn Mitchell, Yellowhead County (CA)

(72) Inventor: Dawn Mitchell, Yellowhead County (CA)

(21) Appl. No.: 15/610,487

(22) Filed: May 31, 2017

(51) Int. Cl. G06K 9/00; G06F 17/28; G10L 17/26

(52) U.S. Cl. CPC G06K 9/00892; G06K 9/00671; G10L 17/26; G06F 17/28

(57) ABSTRACT

A sound and image identifier software system includes a computing device having a processor unit, a database storing a plurality of sounds and images, a memory a sound analyzer, and a global positioning system. The computing device may comprise a smartphone or other electronic device which may allow a user to view results through a mobile application. The global positioning system is configured to provide results specific to a region. The output-results after analyzing are provided for a user via electronic device display. The output-results may include profiles on a plurality of species of mammals, birds, fish, reptiles, plants, and insects.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of mobile applications and more specifically relates to a sound and image identifier software system and method.

### 2. Description of Related Art

Software applications can be used to display, generate, and communicate electronic communications. Software applications are designed for use on a mobile computing device, such as a smartphone device. By interacting with a user interface on a mobile computing device, a user of the mobile application may interact with various features of the mobile application.

Animals, humans, automobiles, etc., make a wide variety of sounds that may be of interest to an individual. For example, farmers, zoo keepers, pet owners, and the like have long known that many sound and images are meaningful and relate to the animal's identity (e.g., gender, age, size, etc.), behavior, situation, and state of mind. Studies show that there can be a relationship between an animal's behavioral context (e.g., situation/motivational state) and/or identity, and measurable acoustic properties of sounds that the animal makes. Prior approaches have also shown that the acoustic properties of vocalizations produced by humans, birds, various mammals (e.g., primates, deer, dogs, elephants, etc.), anurans and other land and sea-based animals can vary dependent on the behavioral context and/or on the size, gender, and age of the human/animal, thus making it possible, in some cases, to recognize an individual human/animal based on its vocalizations. An efficient means to identify

U.S. Pub. No. 2014/0328486 to Divya Gopinath, et al. relates to analyzing and transmitting environmental sounds. The described analyzing and transmitting environmental sounds includes embodiments which provide analysis and transmission of environmental sounds (e.g., outdoor sounds generated from an environment surrounding an enclosure) to an indoor occupant. Specifically, a sound analyzer is configured to receive a sensor output containing the environmental sounds, and analyze, in real-time, the environmental sounds to determine attributes of each of the environmental sounds. Each attribute is then compared to a collection of known sounds, and classified based on the comparison. the environmental sounds are then output and transmitted to the indoor occupant as at least one of: an audio transmission containing one or more of the environmental sounds, and a display of information about the one or more environmental sounds. The environmental sounds can be broadcast to the indoor occupant in real-time, and/or may be recorded for later analysis and use.

### BRIEF SUMMARY OF THE INVENTION

In view of the foregoing disadvantages inherent in the known mobile application art, the present disclosure provides a novel sound and image identifier software system and method. The general purpose of the present disclosure, which will be described subsequently in greater detail, is to provide a sound and image identifier for sound and images using a mobile application which provides a brief summary of the bird, animal, reptile, or other animal.

A sound and image identifier software system and method is disclosed herein. The sound and image identifier software system and method includes a computing device having a processor unit, a database storing a plurality of sounds and images, a memory a sound analyzer, and a global positioning system. The computing device may comprise a smartphone or other electronic device which may allow a user to view results through a mobile application. The global positioning system is configured to provide results specific to a region. The output-results, after analyzing, are provided for a user via electronic device display. The output-results may comprise profiles on a plurality of species of mammals, birds, fish, reptiles, plants, and insects. The profile comprises information regarding an identified species. Global positioning system “GPS” capabilities allow the sound and image identifier software system to narrow down what species is being observed.

A method of using the sound and image identifier software system is also disclosed herein. The method of using the sound and image identifier software system and method may comprise the steps of: recording of the user-input for a set amount of time to be analyzed and identified, receiving user-input, analyzing and comparing the user-input with a plurality of sounds and images stored within a database, identifying and matching the user-input with a plurality of sounds and images stored within a database, outputting output-results for a user to view via an electronic device display, and translating the output-results.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a sound and image identifier software system and method, constructed and operative according to the teachings of the present disclosure.

FIG. 1 is a perspective view of the sound and image identifier software system and method during an ‘in-use’ condition, according to an embodiment of the disclosure.

FIG. 2 is a flowchart of the sound and image identifier software system and method of FIG. 1, according to an embodiment of the present disclosure.

FIG. 3 is a flowchart of the sound and image identifier software system and method of FIG. 1, according to an embodiment of the present disclosure.

FIG. 4 is a flowchart of the sound and image identifier software system and method of FIG. 1, according to an embodiment of the present disclosure.

FIG. 5 is a flow diagram illustrating a method of use for the sound and image identifier software system and method, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a mobile application and more particularly to a sound and image identifier software system and method as used to improve the efficiency and accuracy in identification of sounds and images.

Generally, sound and image identifier software system is able to identify mammals, birds, fish, reptiles and insects by their vocal(s) or created sounds or by a picture taken by the user. The sound and image identifier software system may further be configured to identify plants, motorized machines, rocks and dirt by a picture or sound taken by the user. The present invention may include means to identify building structures and monuments, historical, current and cultural by taking a picture.

Global positioning system “GPS” capabilities allow the sound and image identifier software system to narrow down what species would most likely be in an area and a user may then be able to upload information to environmentalist and government agencies for record keeping. Users may upload information they have recorded and recognized by the mobile application and apply that information to the mobile application's personal diary, scrapbook, journal for downloading or for a visual presentation. With GPS, the sound and image identifier software system may provide hikers, teachers, students, guides, or other users with a list of possible species of mammals, birds, structures and such that they might encounter when entering an area. This would not only encourage interest in the users' exploration of an area, but would help to caution the user, for example, to watch for the more dangerous species that may be in the area. As an example, tourists from other countries may be unaware of the various dangerous species they may encounter. The sound and image identifier software system may provide a safety plan should the user encounter a dangerous species and/or specific first aid instructions as well as direct dial to local emergency services should they require it.

Once the sound and image identifier software system identifies a mammal, bird, fish, reptile or insect, the sound and image identifier software system may provide an on-screen summary of the species, visual of the mammal or bird and an option to play back the sound they make. For a more in depth look at the species a link may be provided. The mobile application may allow for a 10, 20, or 30 second recording in order for the user identify all of the species during that time period. It would then send pictures, summaries, links, and play back calls of all the mammals, birds, fish, reptiles and insects identified during the recording.

The sound and image identifier software system may be configured to send a GPS location to emergency services when needed. The mobile application may be multi-lingual for users visiting a foreign country.

Should the user try to use the sound and image identifier software system in a zoo, for example, a message saying that the species they were trying to identify is not native to the area the GPS indicates they are presently in. The present invention may include footprint identification and the ability to upload information in areas with no cellular service and store and recall information once back in service.

A children's version of the present invention may include a simplified version of the above with easier language and larger print. It would still provide a link to a more in depth description of the species and suggest age appropriate books they might like to read for further study on the subject. The children's version of the sound and image identifier software system may provide the ability to record and journal adventures in a diary or scrapbook as well as pictures and include play back options.

A hunt and seek game version may also be available to play both competitively and independently of others. Players would receive their hunt and seek goal for the day/week. They would be given a sound, picture and possible habitat areas that the mammals, birds, fish, reptiles and insects might be near their current location. They then need to ‘capture’ a picture or sound of the species and record it to their scoreboard for points. There may be a children's version and an adult version. The children's version may have a setting for parents to set a hunt and seek boundary notifying both the parent on their mobile device and the child when they have reached their boundary limit.

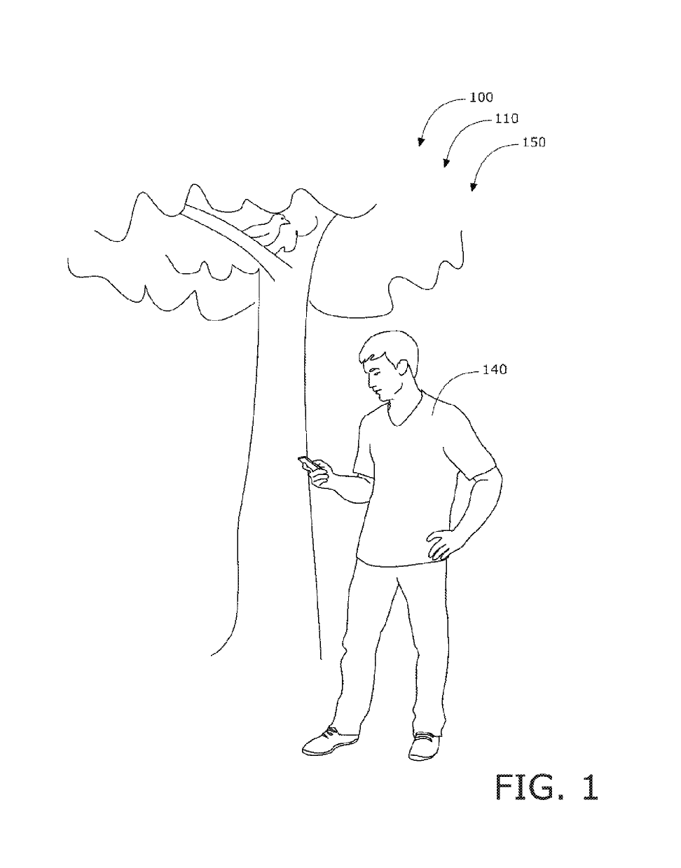

Referring now more specifically to the drawings by numerals of reference, there is shown in FIG. 1 a perspective view during an in-use condition and 2-5 show various flowcharts and flow diagrams of a sound and image identifier software system and method 100. FIG. 1 shows a sound and image identifier software system and method 100 during an ‘in-use’ condition 150, according to an embodiment of the present disclosure. As illustrated, the sound and image identifier software system and method 100 may include a computing device 110 having a processor unit 120, a database 130 storing a plurality of sounds and images, a memory 136 a sound analyzer 144, and a global positioning system 148.

The sound and image identifier software system 100 includes the computing device 110 comprising the processor unit 120, the database 130, the memory 136, the sound analyzer 144, and the global positioning system 148. The computing device 110 may comprise a smartphone 10 or other electronic device which may allow a user 140 to view results through a mobile application. The global positioning system 148 is also configured to provide results outside of a specific the region and indicate that the identified species is not native to the geographical region.

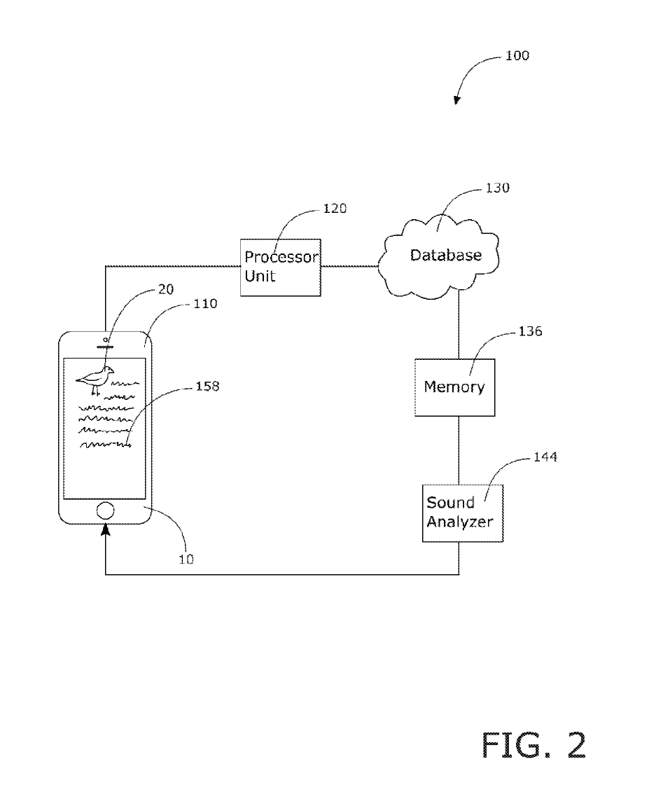

FIG. 2 shows a flowchart of the sound and image identifier software system and method 100 of FIG. 1, according to an embodiment of the present disclosure. As above, the sound and image identifier software system and method 100 may include a computing device 110 having a processor unit 120, a database 130 storing a plurality of sounds and images, a memory 136 a sound analyzer 144, and a global positioning system 148. The memory 136 is in communication with the processor unit 120. The sound analyzer 144 means is stored within the memory 136 and is configured to analyze and compare a user-inputted-sound and user-inputted-image with the sounds and the images stored within the database such that identification is able to be made in a form of output-results 158. The global positioning system 148 is configured to provide results specific to a region. The output-results 158 after analyzing are provided for a user via electronic device display. The output-results 158 may comprise profiles on a plurality of species of mammals, birds, fish, reptiles, plants, and insects. The profile may comprise information regarding an identified species.

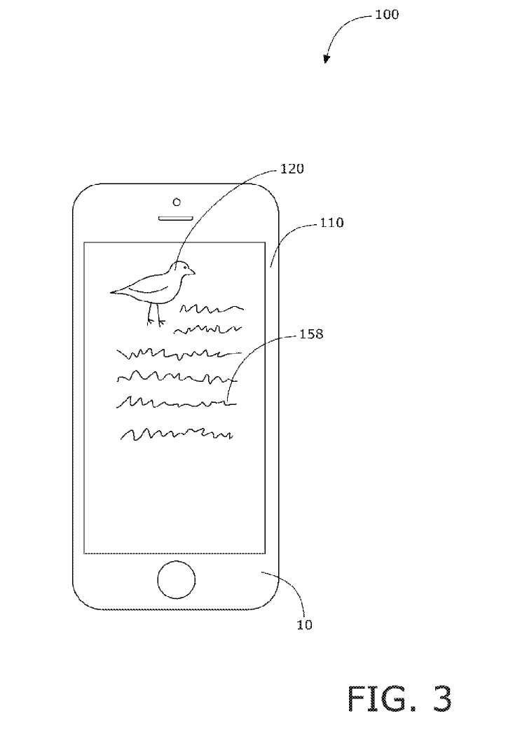

FIG. 3 shows a flowchart of the sound and image identifier software system and method 100 of FIG. 1, according to an embodiment of the present disclosure. As above, the sound and image identifier software system and method 100 may include a computing device 110 comprising a processor unit 120, a database 130 storing a plurality of sounds and images, a memory 136, a sound analyzer 144, and a global positioning system 148. The database 130 further comprises profiles on a variety of building structures and landmarks which may be matched with the user-inputted-images. The database 130 further comprises profiles on a variety of motorized machines which may be matched with the user-inputted-sound. The database 130 further comprises profiles on a variety of rocks, dirt, and feces which may be matched with the user-inputted-images. Other items may be analyzed.

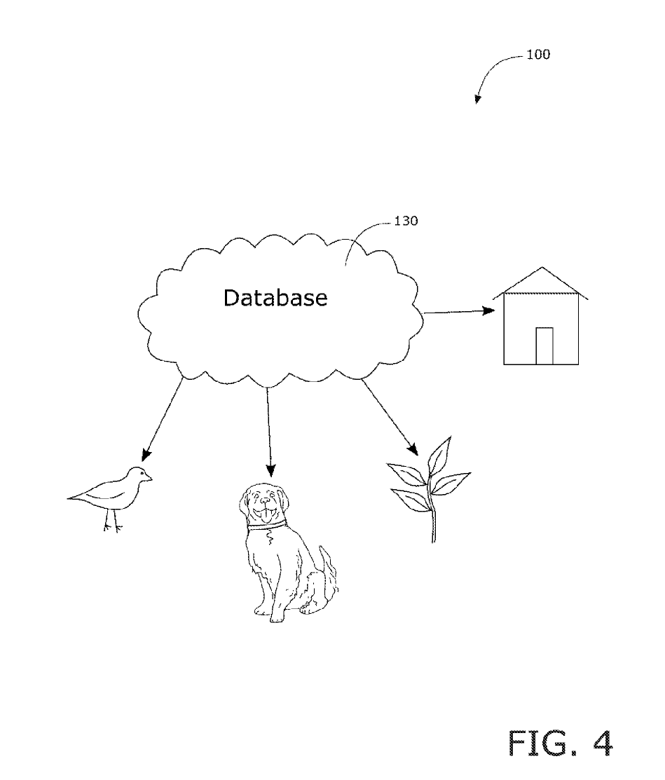

FIG. 4 shows a front perspective view of the sound and image identifier software system and method 100 of FIG. 1, according to an embodiment of the present disclosure. As above, the sound and image identifier software system and method 100 may include a computing device 110 having a processor unit 120, a database 130 storing a plurality of sounds and images, a memory 136, a sound analyzer 144, and a global positioning system 148. The output-results 158 may also be played back to a user 140 via audio playback. The output-results 158 may include warnings for identified species 20 of plants and animals which may dangerous and include information and help regarding the identified species 20. The output-results 158 may further comprise a link to an external source for additional information. The output-results 158 may be provided in various languages for foreign users. The output-results 158 are able to be recorded and available for later use. The output-results 158 are provided for a user via electronic device display through a mobile application. The mobile application of the present invention allows the user to diary information and the output-results 158.

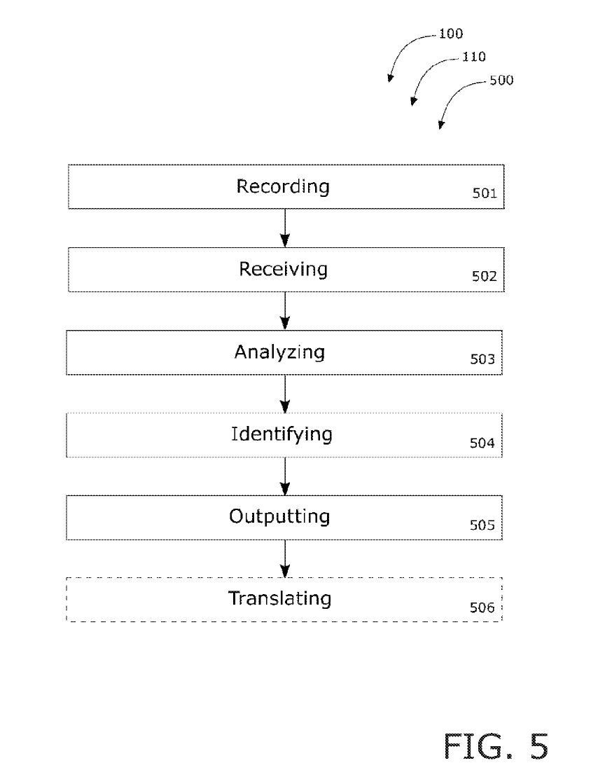

FIG. 5 is a flow diagram 550 illustrating a method for analyzing and identifying sounds and images 500, according to an embodiment of the present disclosure. As illustrated, the method for analyzing and identifying sounds and images 500 may include the steps of: step one 501, recording of the user-input for a set amount of time to be analyzed and identified; step one 501, receiving user-input; step one 501, analyzing and comparing the user-input with a plurality of sounds and images stored within a database 130; step one 501, identifying and matching the user-input with a plurality of sounds and images stored within a database 130; step one 501, outputting output-results 158 for a user 140 to view via an electronic device display; and step one 501, translating the output-results 158.

It should be noted that step one 501 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for identifying sounds and images 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A sound and image identifier software system and method comprising:
a computing device comprising;
a processor unit;
a database storing a plurality of sounds and images;
a memory;
a sound analyzer; and
a global positioning system;
wherein said sound and image identifier software system comprises said computing device;
wherein said computing device comprises said processor unit, said database, said memory, said sound analyzer, and said global positioning system;
wherein said memory is in communication with said processor unit;
wherein said sound analyzer means is stored within said memory and is configured to analyze and compare a user-inputted-sound and user-inputted-image with said sounds and said images stored within said database such that identification is able to be made in a form of output-results;
wherein said global positioning system is configured to provide results specific to a region; and
wherein said output-results after analyzing are provided for a user via electronic device display.

2. The sound and image identifier software system and method of claim 1, wherein said output-results comprise profiles on a plurality of species of mammals, birds, fish, reptiles, plants, and insects.

3. The sound and image identifier software system and method of claim 2, wherein said profile comprises information regarding an identified species.

4. The sound and image identifier software system and method of claim 2, wherein said output-results comprises audio playback.

5. The sound and image identifier software system and method of claim 3, wherein said output-results comprise warnings for dangerous said identified species.

6. The sound and image identifier software system and method of claim 1, wherein said output-results further comprises a link to an external source for additional information.

7. The sound and image identifier software system and method of claim 1, wherein said computing device comprises a smartphone.

8. The sound and image identifier software system and method of claim 1, wherein said database further comprises building structures and landmarks which may be matched with said user-inputted-images.

9. The sound and image identifier software system and method of claim 1, wherein said database further comprises motorized machines which may be matched with said user-inputted-sound.

10. The sound and image identifier software system and method of claim 1, wherein said database further comprises rocks and dirt which may be matched with said user-inputted-images.

11. The sound and image identifier software system and method of claim 1, wherein said output-results are able to be recorded and available for later use.

12. The sound and image identifier software system and method of claim 1, wherein said output-results are provided for a user via electronic device display through a mobile application.

13. The sound and image identifier software system and method of claim 1, wherein said mobile application allows said user to diary information and said output-results.

14. The sound and image identifier software system and method of claim 1, wherein said output-results are multi-lingual.

15. The sound and image identifier software system and method of claim 1, wherein said global positioning system is configured to provide results outside of a specific said region.

16. The sound and image identifier software system and method of claim 1, wherein said database further comprises feces which may be matched with said user-inputted-images.

17. The sound and image identifier software system and method of claim 1, wherein said output-results comprise a recording for a set amount of time to identify a plurality of user-inputted-sounds.

18. A method for analyzing and identifying sounds and images, the method comprising the computer-implemented steps of:
receiving user-input;
analyzing and comparing said user-input with a plurality of sounds and images stored within a database;
identifying and matching said user-input with a plurality of sounds and images stored within a database; and
outputting output-results for a user to view via an electronic device display.

19. The method according to claim 18, further comprising translating said output-results.

20. The method according to claim 18, further comprising recording of said user-input for a set amount of time to be analyzed and identified.
